(19) United States
(12) Patent Application Publication
(10) Pub. No.: US 2015/0073949 A1
(43) Pub. Date: Mar. 12, 2015

(54) SYSTEM AND METHOD FOR PERFORMING RECONCILIATION OF AN ACCOUNT USING AT LEAST THREE SETS OF RECORDS

(71) Applicant: Clearwater Analytics, LLC, Boise, ID (US)

(72) Inventors: Phillip Ashton Armstrong, Meridian, ID (US); Tyler Mckay Haws, Boise, ID (US); Jerek J. Anderson, Boise, ID (US); Shawn Russell O'Neill, Boise, ID (US); Scott Stanley Erickson, Boise, ID (US)

(21) Appl. No.: 14/023,363

(22) Filed: Sep. 10, 2013

(51) Int. Cl. G06Q 40/00

(52) U.S. Cl. CPC G06Q 40/12
USPC 705/30

(57) ABSTRACT

A method and system for reconciling an account among three data sources, including data provided by or on behalf of an entity, data provided by an asset manager, and data provided by a custodian of an account held by the entity. The system identifies data provided by the entity and receives data from the asset manager and data from the custodian on a daily basis. The system normalizes and aggregates the data. The system matches transactions and positions executed on behalf of the entity among the three data sets. The system compares data associated with matched transactions and positions among the three data sets. If the system identifies any differences in the data associated with a matched transaction and positions among the three data sets, the system reconciles the data. The system may also generate a reconciliation report.

### BACKGROUND

Reconciliation is a process by which an account holder verifies the accuracy of account data by comparing multiple sets of records associated with the account to ensure that they are in agreement. When discrepancies among the records are discovered, the account holder can make corrections so that the information in the records is accurate and consistent. Reconciliation may be utilized to ensure that an account has not suffered from any errors or fraud.

To perform reconciliation, an account holder must have access to at least two sets of records. The account holder may possess or control one set, but typically the account holder relies on a third party to furnish an additional set of records. This dependency limits the frequency by which reconciliation may be performed, resulting in most account holders reconciling their accounts at the end of accounting periods, such as at the end of every month.

Some account holders suffer little harm by having to wait until the end of an accounting period to reconcile their accounts. But others may lose money by foregoing investments or taking miscalculated risks based on incorrect accounting data. For example, an investor trading on margin may use an account balance as collateral. If, due to an accounting error, the investor believes that a balance of the account is lower than it actually is, the investor may unduly limit the trades he or she executes on margin.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a tri-party reconciliation system may operate.

FIG. 2 is a block diagram of a tri-party reconciliation system.

FIG. 3 is a flow diagram depicting a method performed by a tri-party reconciliation system to identify and reconcile discrepancies in data of multiple records associated with an account.

FIG. 4 is a table generated by a tri-party reconciliation system for reporting discrepancies among records associated with an account.

FIG. 5 is a flow diagram depicting a method performed by a tri-party reconciliation system to generate a reconciliation report.

FIG. 6 is a flow diagram depicting a method performed by a tri-party reconciliation system to identify error trends in data provided to the tri-party reconciliation system by various sources.

### DETAILED DESCRIPTION

A method and system are described for reconciling differences in financial data associated with an account held by an entity. The system performs reconciliation based on three data sources: a first data source maintained by or on behalf of the entity, a second data source received from an asset manager associated with the entity, and a third data source received from a custodian associated with the entity. The system reconciles differences among the data sources and produces reports describing reconciled data. The system also reports reconciliation breaks back to asset managers and custodians and identifies trends associated with errors in data supplied by the asset managers and custodians.

The system normalizes and aggregates received manager transaction and position data and custodian transaction and position data. The system also predicts and enters predictable transactions in entity account data, such as dividends and interest payments. It compares entity account data with the manager transaction/position data and custodian transaction/position data and identifies matching transactions/positions. The system also identifies transactions/positions that do not match, such as when one data source identifies a transaction or position that is not reflected in another data source. The system compares data values associated with matched transactions/positions among the data sources and identifies differences in the data values. The system reconciles the differences in data values among matched transactions and positions based on reconciliation rules. In some implementations, the system reconciles a difference in data values by generating a graphical user interface and receiving a selection or submission of a data value from a user associated with the entity.

The system generates reconciliation reports, which the system may output to the entity and/or to asset managers and custodians. The system also identifies trends associated with errors in transaction/position data received from asset managers and custodians. For example, the system may identify a quantity of errors over a period of time produced by each asset manager that an entity deals with, and output trend data to the entity to help the entity identify error-prone asset managers and custodians.

The disclosed system and method increase the frequency by which an entity may reconcile its accounts. For example, reconciliation may be performed on a daily basis, or a weekly basis, rather than at the end of each month or quarter. By increasing reconciliation frequency, the entity can more quickly recognize errors in its or a third party's financial data. The entity may therefore reduce risk associated with transactions that depend on the entity having an accurate understanding of its financial resources. The entity may also allocate resources according to accurate financial data, allowing the entity to maximize profitability of its financial resources.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for tracking financial accounting events and processing, arranging, and portraying information associated with those accounting events. The systems are described with respect to a number of processes that they may implement and numerous examples of how they may be implemented.

### Suitable Environments

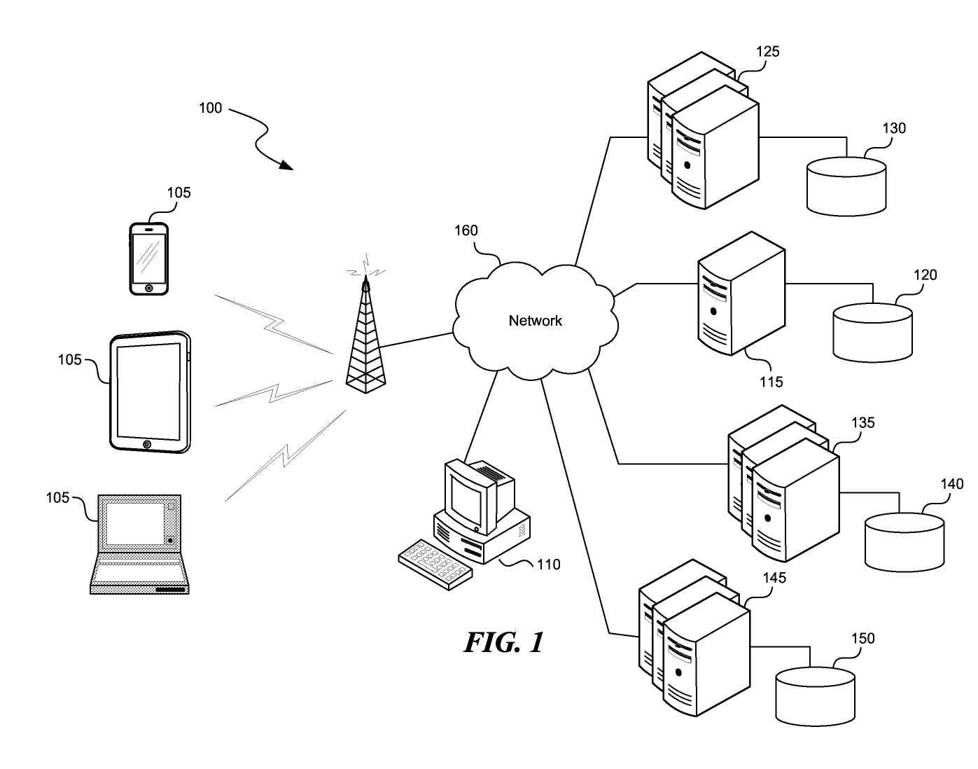

FIG. 1 and the following discussion provide a brief, general description of a suitable computing environment 100 in which a tri-party reconciliation system can be implemented. Although not required, aspects and implementations of the invention will be described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a tri-party reconciliation system according to embodiments of the invention operates in or among mobile devices 105, personal computers 110, and one or more server computers 115. The mobile devices 105 and personal computers 115 communicate through one or more wired or wireless networks 160 with the server 115. A data storage area 120 contains data utilized by the tri-party reconciliation system, and, in some implementations, software necessary to perform functions of the system. For example, the data storage area 120 may contain data pertaining to a company's finances, including account data and historical transaction and position data, reconciliation rules, software to generate reconciliation reports, etc.

The tri-party reconciliation system communicates with one or more third party manager servers 125 via public or private networks. The third party manager servers include servers maintained by entities, such as asset managers, that periodically send manager transaction and position data to the server 115. The manager transaction/position data may pertain to any transaction or posting, cash flow information, or position information associated with an account held by an entity, whether purchases or sales of a security, coupons, paydowns, dividends, maturities, cash positions, financial instrument analytics (e.g., price, yield, duration held, cash flows), cash deposits, loans, or the like. For example, the manager transaction/position data may include current day trading information, such as purchases or sales of shares of a stock, current day cash flows, ending day position information, and the like. The tri-party reconciliation system normalizes the manager transaction/position data and uses it to reconcile an account held by the entity. The system stores received and normalized manager transaction/position data and data produced during reconciliation of the account in data storage areas 120. Data storage areas 120 may also contain data received from or produced by the tri-party reconciliation system for mobile devices 105 or personal computers 110.

The tri-party reconciliation system also communicates with one or more third party custodian servers 135 via the public or private networks. The third party custodian servers include servers maintained by entities that periodically send custodian transaction/position data to the server 115. The custodian transaction/position data may pertain to any transaction or financial position associated with an account held by an entity with a third party custodian. For example, the custodian transaction/position data may include data pertaining to cash holdings of an entity or information describing debits to the account as a result of trades commenced on the entity's behalf. The tri-party reconciliation system normalizes the custodian transaction/position data and stores it in data storage areas 120.

The tri-party reconciliation system also communicates with one or more third party servers 145. Third party servers 145 access data storage areas 150 and provide data pertaining to financial instruments. For example, third party servers may provide analytic data associated with a security, such as an asking price for a stock traded on a stock exchange, a yield associated with the stock, or the like.

The mobile devices 105 and computers 110 communicate with each other and the server 115 and third party servers 125 through networks 160, including, for example, the Internet. The mobile devices 105 communicate wirelessly with a base station or access point using a wireless mobile telephone standard, such as the Global System for Mobile Communications (GSM), or another wireless standard, such as IEEE 802.11, and the base station or access point communicates with the server 115 via the networks 160. Computers 110 communicate through the networks 160 using, for example, TCP/IP protocols.

### Suitable Systems

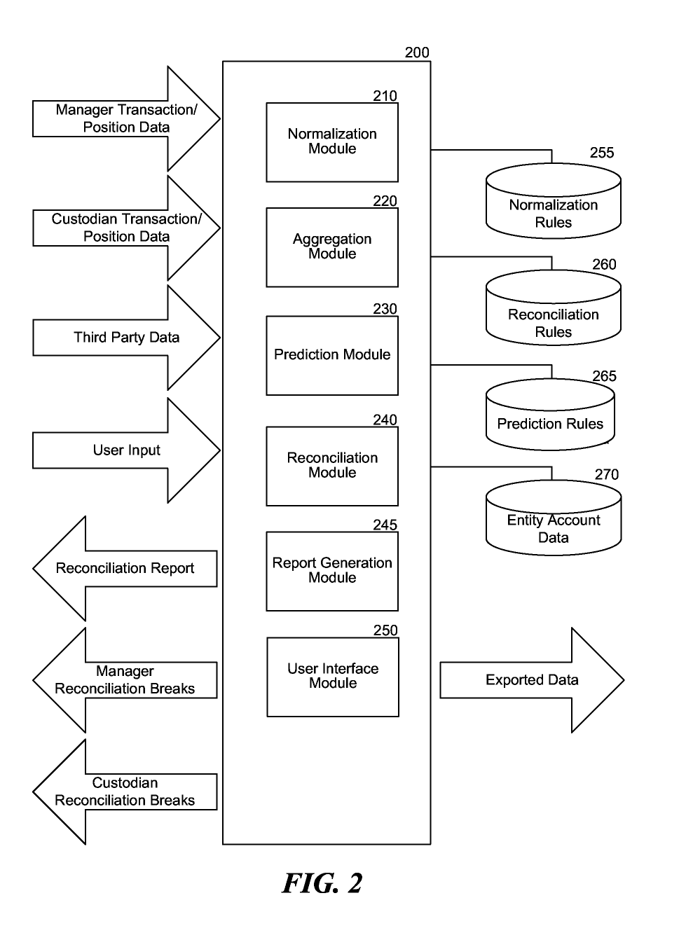

FIG. 2 is a block diagram of a tri-party reconciliation system 200. The tri-party reconciliation system 200 receives manager transaction/position data, custodian transaction/position data, third party data, and user input, and uses this data to perform reconciliation for at least one account associated with an entity. The system generates and outputs to an entity a reconciliation report. The system also identifies manager reconciliation breaks and custodian reconciliation breaks, and transmits this information to third party asset managers and third party custodians, respectively. The system includes a normalization module 210, an aggregation module 220, a prediction module 230, a reconciliation module 240, a report generation module 245, and a user interface module 250, the operation of each of which will be described in greater detail herein. The tri-party reconciliation system 200 accesses data storage areas, including normalization rules data storage area 255, reconciliation rules data storage area 260, prediction rules data storage area 265, and entity account data storage area 270.

The tri-party reconciliation system 200 reconciles account data among entity account data, manager transaction/position data, and custodian transaction/position data. The tri-party reconciliation system obtains and stores entity account data in entity account data storage area 270. Entity account data includes information pertaining to balances of at least one account held by an entity and financial transactions that have been executed with respect to the at least one account. Entity account data is maintained by the entity or on behalf of the entity by the system 200. In some implementations, entity account data includes accounting event data, such as activities and balances associated with an account held by the entity. Data may be exported from the system 200 for use in other financial management functions, such as compliance monitoring, risk assessment, performance monitoring, and generation of accounting statements. Further details regarding obtaining accounting event data, identifying activities and balances, and financial management functions can be found in the assignee's commonly-owned U.S. patent application Ser. No. 13/658,603, entitled SYSTEM AND METHOD FOR APPLYING DIVERSE ACCOUNTING EVENTS TO ACCOUNT BALANCES AND GENERATING FINANCIAL REPORTS, which is incorporated herein by reference in its entirety.

The tri-party reconciliation system 200 receives manager transaction/position data from one or more third-party asset managers, or the like, that are associated with an entity. Manager transaction/position data includes data pertaining to transactions executed with respect to an account held by the entity and balances associated with the account. For example, manager transaction/position data includes data related to the buying and selling of a security or other financial instruments and financial analytics pertaining to the trade or the security traded, such as price, yield, duration held, WaL, cash flows, etc. The system may receive manager transaction/position data periodically. In some implementations, the system receives manager transaction/position data after a relevant exchange closes. For example, an investment manager may send data pertaining to stock trades executed on an entity's behalf at the close of a stock exchange through which the shares of the stock were traded (e.g., at or shortly after 4:00 pm EST for trades executed on the New York Stock Exchange). In some implementations, the system receives manager transaction/position data on a daily basis, and in other implementations, the system receives manager transaction position data more frequently or less frequently, such as every hour or every other day. Manager transaction/position data may be received in various formats. In some implementations, manager transaction/position data is received in a format proprietary to the tri-party reconciliation system or the asset manager that sends the data. In some implementations, manager transaction/position data is received in a format used by a spreadsheet application, such as .xls format. In some implementations, manager transaction/position data is raw data.

The tri-party reconciliation system 200 receives custodian transaction/position data from one or more financial custodians associated with an entity. Custodian transaction/position data includes information pertaining to custody transactions associated with an account held by the entity, such as cash flows, and position information associated with an account held by the entity. In some implementations, the tri-party reconciliation system receives custodian transaction/position data after receiving the manager transaction/position data but prior to the next business day after the manager transaction/position data is received. For example, the tri-party reconciliation system 200 may retrieve custodian transaction/position data by 3:00 am EST on the day after the manager transaction/position data is received. In some implementations, custodian transaction/position data is received or retrieved less frequently, such as every week or two weeks. Custodian transaction/position data may be received in various formats. In some implementations, custodian transaction/position data is received in a format proprietary to the tri-party reconciliation system or the custodian supplying the data. In some implementations, custodian transaction/position data is received in a format used by a spreadsheet application, such as .xls format. In some implementations, custodian transaction/position data is raw data.

The tri-party reconciliation system 200 also receives third party data from third party sources, such as Bloomberg™. Third party data includes information related to assets and securities, such as market prices of securities, yields associated with a security, interest rates associated with an account, and so forth.

The tri-party reconciliation system also receives user input. User input includes information provided by a representative of an entity. User input includes a selection or submission of a data value associated with a transaction. For example, the tri-party reconciliation system may generate and display a reconciliation report to a user, describing transactions associated with an account and highlighting disagreements among data sources with respect to data values of the transactions. The system may receive a selection or submission of a data value from a user and reconcile a disagreement among the data sources based on this input from the user.

The tri-party reconciliation system 200 generates a reconciliation report based at least in part on the entity account data, manager transaction/position data, and custodian transaction/position data. The reconciliation report includes information pertaining to at least one account associated with an entity. In some implementations, the reconciliation report identifies disagreements among data sources with regard to a data value of a transaction. For example, the system may automatically reconcile a data value among multiple data sources but flag the data value in a reconciliation report so that the user may change the value if the user does not agree with the reconciled value. In some implementations, the system generates the reconciliation report by executing an extract, transform, load (ETL) run on account data associated with the entity, including custodian transaction/position data and manager transaction/position data. The tri-party reconciliation system 200 also identifies manager reconciliation breaks and custodian reconciliation brakes. Manager reconciliation breaks and custodian reconciliation breaks identify errors in manager transaction/position data and custodian transaction/position data, respectively, which are determined after the system reconciles discrepancies in transaction/position data. The tri-party reconciliation system may send manager and custodian reconciliation breaks to relevant asset managers and custodians for review, analysis, and action.

The normalization module 210 receives and normalizes entity account data, received manager transaction/position data, and received custodian transaction/position data to prepare data from the data sources for reconciliation. The normalization module normalizes this data based on normalization rules stored in normalization rules data storage area 255. Normalization rules may specify, for example, a currency to be used for reconciliation, a number of significant figures to use for representing money, time and date conventions, and so forth. Normalization rules may also specify how to normalize data to the standards specified. For example, a normalization rule for converting currency may specify that a trade in Canadian dollars should be multiplied by an exchange rate between the Canadian dollar and the United States dollar to normalize the trade to United States dollars.

The normalization module provides normalized transaction/position data to the aggregation module. The aggregation module 220 aggregates normalized manager transaction/position data and custodian transaction/position data with stored entity manager transaction/position data and custodian transaction/position data. The aggregation module retrieves stored transaction/position data and other account data from entity account data storage area 270, and it may store aggregated transaction/position data in the entity account data storage area as well. In some implementations, the aggregation module enters into the entity account data un-reconciled transactions from the manager transaction/position data. The aggregation module also receives information from the reconciliation module regarding unmatched transactions. If manager transaction/position data describes a transaction that is not matched in entity account data, the aggregation module may insert the transaction from the manager transaction/position data into the entity account data.

The prediction module 230 predicts cash flows and enters un-reconciled predictable transactions in aggregated entity account data. For example, based on an account's holdings, the prediction module may enter coupons, paydowns, dividends, maturities, and the like, into the aggregated entity account data. The prediction module predicts the cash flows and predictable transactions based on prediction rules stored in prediction rules data storage area 265. Prediction rules may specify, for example, that a dividend is to be calculated and entered on a particular date by multiplying a number of shares of a stock held by an entity with a dividend rate for the stock.

The reconciliation module 240 reconciles data associated with transactions among normalized and aggregated entity account data, manager transaction/position data, and custodian transaction/position data. To reconcile transaction/position data among these data sources, the reconciliation module first matches transactions (e.g., predictable transactions, coupon payments, principle paydowns, security transfers, trades, etc.) and positions among the data sources. In some implementations, transactions and positions are matched by comparing common properties associated with the transactions and position, respectively, and identifying similarities in data values associated with those properties. For example, each transaction in entity account data, manager transaction/position data, and custodian transaction/position data may be associated with a date and time that a transaction was executed, a cash value of the transaction, a quantity of a security involved in the transaction (e.g., number of shares), or the like. The reconciliation module may determine that transactions match between two or more data sources when the common property between or among two or more transactions has a value that is the same or substantially similar. The reconciliation module similarly matches positions among the three data sources. For example, the reconciliation module may determine that positions between two data sources matches when values of positions among data sources are identical or were identical at a previous point in time. In some implementations, the reconciliation module determines that transactions or positions from two different data sources match when each is associated with the same unique identifier. The reconciliation module may sometimes identify transactions or positions from one data source that do not match with any transactions or positions, respectively, from another data source. When an unmatched transaction or position is identified, the reconciliation module may provide the aggregation module with information related to the unmatched transaction or position. The reconciliation module may also flag unmatched transactions and positions so that a user can be alerted that a transaction or position was not matched.

After matching transactions and positions among the data sources, the reconciliation module reconciles differences in data values that are specified by the data sources for the matched transactions and positions. The reconciliation module 240 can reconcile a disagreement among data sources in many ways. In some implementations, the reconciliation module reconciles transactions or positions in favor of data supplied by a particular data source. For example, if there is a discrepancy between proceeds of a predictable transaction as predicted based on entity account data and proceeds for the predictable transaction as specified in custodian transaction/position data, the reconciliation module may reconcile the disagreement in favor of the custodian transaction/position data. In some implementations, the reconciliation module reconciles differences in transaction or position data among multiple data sources by reconciling discrepancies in favor of the most common value for the transaction or position data among the multiple data sources. For example, if a stock trade is matched among entity account data, manager transaction/position data, and custodian transaction/position data, and the entity account data and custodian transaction/position data agree on a purchase price for the stock, the reconciliation module can reconcile a different purchase price specified by manager transaction/position data in favor of the purchase price specified by both the entity account data and the custodian transaction/position data. In reconciling transaction/position data in favor of transaction/position data specified by a majority of data sources, the reconciliation module may not consider a data source from the majority when the transaction/position data was copied directly to the data source from another of the majority sources. For example, if the aggregation module copies an unmatched trade from manager transaction/position data to entity account data, the reconciliation module may not reconcile a disagreement among the data sources in favor of the manager transaction/position data and entity account data merely because they represent a majority over custodian transaction/position data.

The reconciliation module may also reconcile conflicting transaction/position data among data sources based at least in part on the transaction/position data itself. For example, in some implementations, the system may reconcile differing trade values among data sources in favor of a trade value that is more likely to be accurate based on a particular trade, entity for which the trade was executed, asset manager who executed the trade, custodian, or the like. For example, if an entity typically buys and sells shares of stock in blocks worth less than $1 Million, and a trade value associated with a trade for the entity is reported by manager transaction/position data to be $100 Million and by the custodian transaction/position data trade to be $100,000, the system may reconcile the trade value in favor of the custodian transaction/position data. In some implementations, the tri-party reconciliation system resolves a transaction or position value that conflicts between data sources in favor of a particular data source. For example, if a particular custodian is associated with an extremely high error-free rate (e.g., successfully identifies a correct trade value 99.999% of the time in testing), the system may reconcile discrepancies among transaction or position values in favor of the custodian.

In some implementations, the reconciliation module may reconcile differences in transaction/position data based on user input. For example, the user interface module 250 may generate a user interface that identifies discrepancies in transaction/position data among data sources. The tri-party reconciliation system may receive input from a technician identifying transaction/position data to use for reconciling a conflict among data sources. For example, the system may generate a user interface that displays a report highlighting conflicting trade values among data sources. The system may receive a selection of a trade value for resolving the conflict among the data sources.

The reconciliation module also identifies trends associated with historical reconciliation of an account held by an entity. For example, the reconciliation module may record the number of times that an asset manager or custodian supplies transaction/position data that is incorrect over a period of time. The reconciliation module may discover trends that help an entity evaluate whether an asset manager or custodian is reliable enough for a continued relationship.

The report generation module 245 receives data from the reconciliation module, prediction module, and aggregation module, and generates a report that is to be supplied to a user or to an asset manager or custodian. The report may describe reconciled transaction/position data, discrepancies in transaction/position data among the data sources, account balances, matched transactions, unmatched transactions, and so forth. The report generation module also generates manager reconciliation breaks and custodian reconciliation breaks, which may be transmitted to relevant asset managers and custodians, respectively. The report generation module also generates reports related to trends in errors reported in data supplied by asset managers and custodians.

The user interface module 250 generates a user interface for displaying data related to an account associated with an entity and for receiving input from a user associated with the entity. For example, the user interface module may generate a user interface displaying a reconciliation report that describes reconciled transaction/position data and discrepancies in the transaction/position data among entity account data, manager transaction/position data, and custodian transaction/position data. The user interface module may receive input from a user to reconcile discrepancies in transaction/position data or to correct errors in reconciled transaction/position data.

### Example Processes

The tri-party reconciliation system 200 processes entity account data, manager transaction/position data, and custodian transaction/position data, which are all associated with an account held by an entity, and identifies and reconciles deviations among the data. It also generates reconciliation reports, which it outputs to entity users, and reconciliation breaks, which it outputs to relevant asset managers and custodians. The tri-party reconciliation system 200 also identifies trends associated with errors in transaction/position data received from asset managers and custodians, and it generates reports that alert the entity of error-prone managers and custodians.

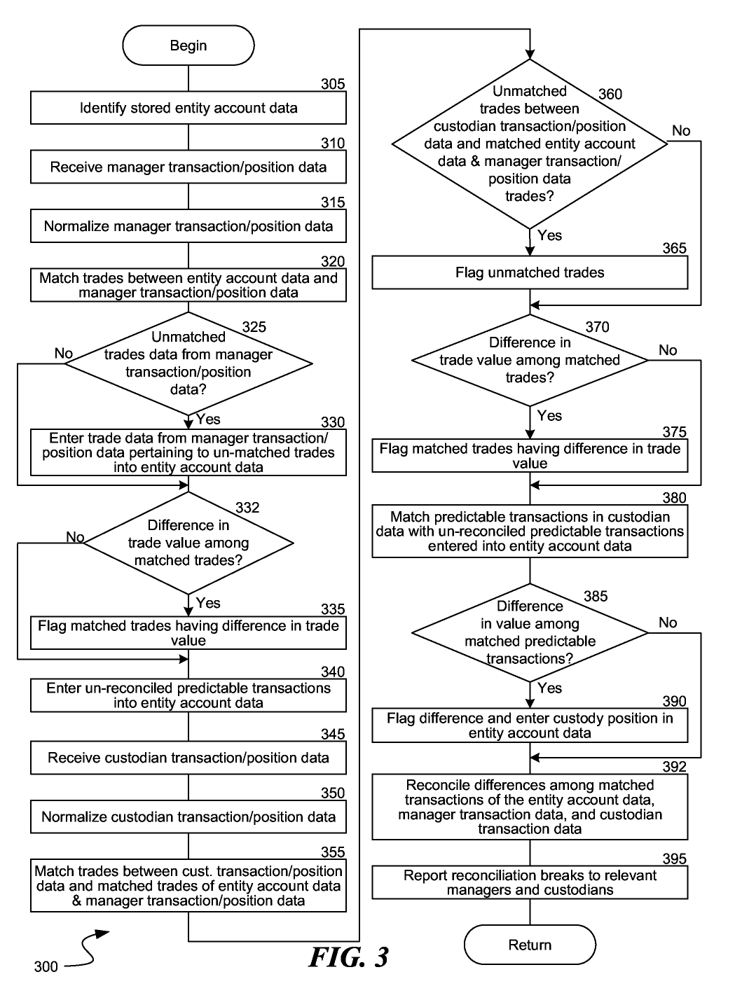

FIG. 3 is a flow diagram representing a process 300 performed by the tri-party reconciliation system 200 for identifying errors in data associated with transactions executed by or on behalf of an entity and for reconciling the errors among three data sources. In some implementations, the tri-party reconciliation system performs the process 300 daily. Transactions include trades (e.g., stock purchases and sales), coupon payments, principle paydowns, security transfers, dividends, maturities, and the like. Although the process 300 is primarily described with respect to transactions, including trades and predictable transactions, the process may occur at both a position and transaction level. Accordingly, in some implementations, the system compares, matches, and reconciles positions among entity account data, manager transaction/position data, and custodian transaction/position data just as it does trades and other transactions in the process described below. At a block 305, the tri-party reconciliation system 200 identifies stored entity account data. Entity account data includes data describing balances associated with an account held by an entity, data describing transactions executed by the entity, data describing accounting events involving the entity, data describing positions held by the entity, and the like. As mentioned above, in some implementations, entity account data includes activities and balances that are derived from accounting events that an entity has been associated with.

At a block 310, the tri-party reconciliation system 200 receives manager transaction/position data from at least one manger of assets and/or investments associated with an account held by the entity. Manager transaction/position data includes transaction data, such as trade data and cash flow data, position data, and the like. Trade data includes data associated with trades executed by the asset manager on behalf of the entity, such as data pertaining to the buying and selling of a security. Cash flow data includes data pertaining to coupons, paydowns, security transfers, dividends, maturities, and the like, which are associated with the account held by the entity. Position data includes ending day position information associated with the account held by the entity, such as basic analytics, including a market price of a security, a market yield, a duration that a security was held for, a convexity, WaL, cash flows, and so forth. In some implementations, manager transaction/position data is received by the tri-party reconciliation system at the close of a relevant exchange. In some implementations, manager transaction/position data is received at another predetermined time, such as at the close of business for an investment manager.

At a block 315, the tri-party reconciliation system 200 normalizes the manager transaction/position data. The manager transaction/position data is normalized so that it is on a common scale with entity account data and custodian transaction/position data, as described further below. By normalizing the data, the tri-party reconciliation system can directly compare the manager transaction/position data with entity account data and custodian transaction/position data. The manager transaction/position data may be normalized by currency, a number of significant digits, a date or time format (e.g., MM/DD/YYYY), and so forth.

At a block 320, the tri-party reconciliation system 200 matches trades between entity account data and manager transaction/position data. The tri-party reconciliation system may match trades, for example, by comparing common properties associated with the trades and identifying similarities in values associated with those properties. As discussed below, the tri-party reconciliation system may match other transactions or positions in similar ways.

At a block 325, the tri-party reconciliation system 200 determines whether the manager transaction/position data describes any trades that do not exist in the entity account data. This determination may be based on the comparison performed at block 320. In some implementations, a trade reflected in manager transaction/position data is flagged as being new and not yet been reported to the entity, and thus, it is not reflected in entity account data. If no trades are unmatched, the process 300 proceeds to a decision block 332. If a trade exist in the manager transaction/position data and not in the entity account data, the process 300 proceeds to a block 330, and the tri-party reconciliation system enters the absent trade into entity account data based on the manager transaction/position data. The system may flag an entered trade in entity account data as well as manager transaction/position data to indicate that the trade has been entered. In some implementations, the system identifies trades in entity account data that are absent from manager transaction/position data. The system flags these absent trades for being absent from the manager transaction/position data.

At decision block 332, the tri-party reconciliation system 200 determines whether there are any differences between trade values of matched trades. Trade values are part of transaction/position data associated with a trade and include price, proceeds, purchased accrued, trade factor, and the like, which are associated with a trade. The determination is made by comparing trade values of matched trades between the entity account data and the manager transaction/position data. If no matched trades have differing trade values, the process 300 proceeds to a block 340. If a matched trade has a trade value that differs between entity account data and manager transaction/position data, the process proceeds to a block 335, and the system flags the trade and the trade value that differ in each of the manager transaction/position data and the entity account data.

At block 340, the tri-party reconciliation system enters un-reconciled predictable transactions into entity account data. These transactions include coupons, paydowns, dividends, maturities, and the like, which the system predicts based on entity account data. For example, entity account data may describe an entity-owned stock that pays a dividend. On the payment date for the dividend, the system enters a predicted dividend into entity account data. The system may predict the value of the dividend based on a number of shares of the stock that the entity owns and publicly available information pertaining to the value of the dividend being paid.

At a block 345, the tri-party reconciliation system 200 receives custodian transaction/position data from at least one custodian associated with an account held by the entity. Custodian transaction/position data includes custody transaction details and holdings associated with the account. In some implementations, custodian transaction/position data is received by the morning after manager transaction/position data is received. For example, custodian transaction/position data may be received after a relevant market closes but before it opens again.

At a block 350, the tri-party reconciliation system 200 normalizes the custodian transaction/position data. The custodian transaction/position data is normalized so that it is on a common scale with entity account data and manager transaction/position data, as discussed above with respect to normalizing manager transaction/position data. This enables custodian transaction/position data to be directly compared to manager transaction/position data and entity account data. Custodian transaction/position data is normalized by currency, a number of significant digits, a date or time format, or the like.

At a block 355, the tri-party reconciliation system 200 matches trades between custodian transaction/position data and matched trades of entity account data and manager transaction/position data, as determined with reference to block 320. In some implementations, trades are matched by comparing common properties associated with the trades and identifying similarities in values associated with those properties. For example, trades in custodian transaction/position data, manager transaction/position data, and entity account data may each be associated with a date and time that the trade was executed, a cash value of the trade, a quantity traded (e.g., number of shares), or the like. The tri-party reconciliation system may identify a match between trades from custodian transaction/position data and matched trades from entity account data and manager transaction/position data when a common property among the trades has a value that is the same or substantially similar. In some implementations, trades from at least two of entity account data, manager transaction/position data, and custodian transaction/position data are each associated with a unique identifier that is matched between the at least two data sources to match a trade.

At a decision block 360, the tri-party reconciliation system determines whether there are any unmatched trades between trades from the custody transaction/position data and the matched entity account data and manager transaction/position data. The matched entity account data and manager transaction/position data includes trades that were referenced in manager transaction/position data and not entity account data but were entered in entity account data, as described with reference to block 330. If there are no unmatched trades among the data sources, the process 300 proceeds to a decision block 370. If there are unmatched trades between the custodian transaction/position data and matched manager transaction/position data and entity account data, the process 300 proceeds to a block 365, and the tri-party reconciliation system 365 flags the unmatched trades in entity account data, manager transaction/position data, and/or custodian transaction/position data.

At decision block 370, the tri-party reconciliation system 200 determines whether there are any differences in trade values among matched trades. As discussed above, trade values include price, proceeds, purchased accrued, trade factor, and so forth. The determination is made by comparing trade values of matched trades among the entity account data, manager transaction/position data, and custodian transaction/position data. If the system does not identify any differences in trade values among matched trades, the process 300 proceeds to a block 380.

If a matched trade is associated with trade values that differ among the data sources, the process proceeds to a block 375, and the tri-party reconciliation system 200 flags the matched trade. In some implementations, the system flags the trade value for the matched trade that differs among the data sets as well. At a block 380, the tri-party reconciliation system matches predictable transactions in custodian transaction/position data with un-reconciled predictable transactions entered into entity account data, as described with reference to block 340. As mentioned above, these predictable transactions include coupons, paydowns, dividends, maturities, and the like. The system may match predictable transactions in the same or similar ways as it does trades, as discussed above with respect to block 320. Accordingly, to match predictable transactions between custodian transaction/position data and entity account data, the system compares data from each of the custodian transaction/position data and the entity account data that is associated with the predictable transactions, such as a date of a transaction, a financial value of a transaction, a security associated with a transaction, an identifier associated with a transaction, an account associated with a transaction, etc. The system determines that predictable transactions match between custodian transaction/position data and entity account data when at least some of the data associated with the transaction in each data set is the same or substantially similar.

At a decision block 385, the tri-party reconciliation system 200 determines whether there are any differences in data values between matched predictable transactions. For example, the system may compare entity account data and custodian transaction/position data of a matched transaction and identify any differences between data values associated with the predictable transaction in the data sets. If there are no differences in data values, the process proceeds to a block 392. If there are differences in data values, the process proceeds to a block 390, and the tri-party reconciliation system 200 flags the transaction in the entity account data and enters the value for the transaction specified by the custodian transaction/position data into the entity account data. In some implementations, the tri-party reconciliation system determines whether there are predictable transactions in entity account data that are not reflected in custodian data, and vice versa. If there is a predictable transaction in one data set and not the other, the system flags the transaction in the data source in which the transaction is present. The system may also add the predictable transaction to the data source in which the transaction is absent and flag the transaction.

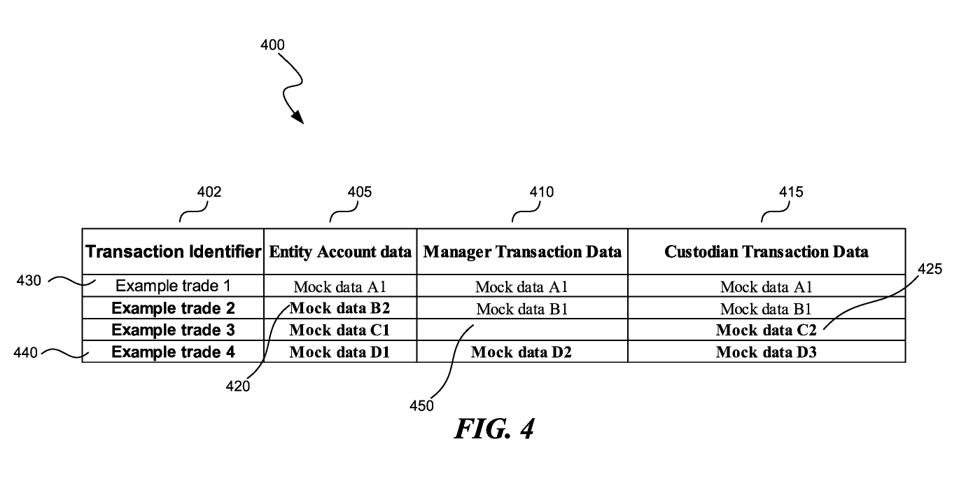

At block 392, the tri-party reconciliation system 200 reconciles differences in trade values for trades that are matched among the entity account data, manager transaction/position data, and custodian transaction/position data. FIG. 4 is a table 200 containing example matched trades 402 and example data values associated with the matched trades from entity account data 405, manager transaction/position data 410, and custodian transaction/position data 415. As discussed above, the tri-party reconciliation system 200 flags trades and/or data values that differ between or among matched trades and missing transactions. In the table 200, flagged data values and trades are bolded. For example, trade value Mock data B2 420 of entity account data is flagged because it corresponds to Example trade 2 and is different from other trade values associated with Example trade 2. Likewise, trade value Mock data C2 425 of custodian transaction/position data is flagged because it has a data value that is different from trade value Mock data C1 of entity account data, and because manager transaction/position data for Example trade 3 is missing, represented by an empty cell 450. Example trade 1 is not flagged because entity account data 405, manager transaction/position data 410, and custodian transaction/position data 415 agree that the trade value for Example trade 1 is Mock data A1.

The tri-party reconciliation system 200 may reconcile differences in trade values associated with a trade in many ways. In some implementations, the tri-party reconciliation system resolves conflicting trade values for a trade among data sources by automatically reconciling the trade in favor of the trade value that two of the three data sources agree upon. For example, referring to FIG. 4, the tri-party reconciliation system may resolve the value of Example trade 2 in favor of Mock data B1, which is contained in manager transaction/position data 410 and custodian transaction/position data 415, but not entity account data 405.

In some implementations, the tri-party reconciliation system 200 reconciles disagreement among data sources with respect to a trade value based on user input. For example, Example trade 4 440 in the table 400 is associated with three different trade values among the entity account data, manager transaction/position data, and custodian transaction/position data. The system may generate a user interface displaying the table 400 and receive, from a user, a selection of a trade value from the entity account data 405, manager transaction/position data 410, or custodian transaction/position data 415 for Example trade 4.

In some implementations, the tri-party reconciliation system resolves conflicting trade values for a trade among data sources by applying different rules depending on the type of underlying transaction/position, the value of the underlying transaction/position, the timing of the underlying transaction/position, or other factor. For example, the reconciliation system may apply a set of rules that will defer to the values maintained by a custodian in the event of a conflicting trade value for one type of transaction/position, but that will defer to the values maintained by a manager in the event of a conflicting trade value for another type of transaction/position. As an example of a value-based rule, trade values under a certain dollar threshold may be automatically reconciled, but trade values above a certain dollar threshold may require a user confirmation.

Referring again to the process 300 of FIG. 3, after reconciling differences among matched transactions, the process proceeds to a block 395, and the tri-party reconciliation system 200 outputs reconciliation breaks to relevant managers and custodians. A reconciliation break identifies errors in transaction/position data received from the relevant asset managers and custodians based on reconciliation of the transaction/position data among entity account data, manager transaction/position data, and custodian transaction/position data. In some implementations, a reconciliation break includes the original data sent by the relevant manager or custodian marked up to show errors. In some implementations, a reconciliation break identifies a transaction and an appropriate data value associated with the transaction, as reconciled by the tri-party reconciliation system 200. In some implementations, a reconciliation break is comprised of a reconciliation report, which may include a table like the table 400 of FIG. 4. After reporting reconciliation breaks, the process 300 returns.

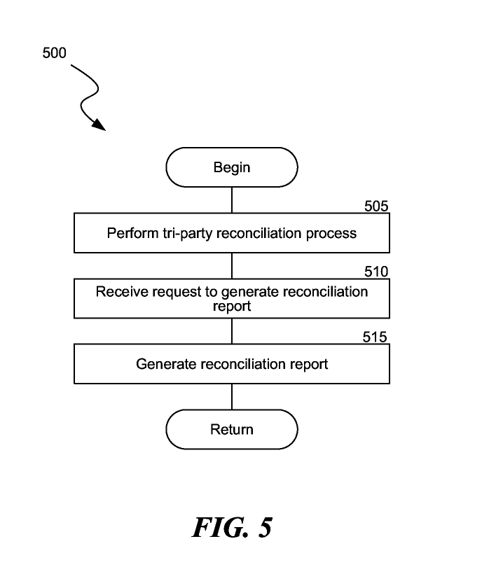

FIG. 5 is a flow diagram representing a process 500 performed by the tri-party reconciliation system 200 for generating a reconciliation report. In some implementations, a reconciliation report is used to solicit input from a user for reconciling a trade value or for matching trades among data sources. The reconciliation report may be supplied to an entity, an asset manager, and/or a custodian to show errors among the data sources or errors in the data that each respective party is responsible for maintaining.

At a block 505, the tri-party reconciliation system 200 performs reconciliation with respect to at least one account held by an entity. For example, the tri-party reconciliation system may perform a reconciliation process like the process 300 described above with respect to FIG. 3. At a block 510, the tri-party reconciliation system receives a request to generate a reconciliation report. The request may be received from a user associated with an entity or it may be automatically generated. For example, the tri-party reconciliation system may be configured to generate a reconciliation report on a periodic basis (e.g., daily) or after a reconciliation process is complete. As another example, the tri-party reconciliation system 200 may be configured to generate a reconciliation report when a quantity of errors identified by the system reaches a predetermined threshold. At a block 515, the tri-party reconciliation system generates a reconciliation report. The reconciliation report identifies reconciled data and transaction data or positions pertaining to a transaction or a position, respectively, that is from entity account data, manager transaction/position data, and custodian transaction/position data. For example, a reconciliation report may include a table similar to the table 400 depicted in FIG. 4. In some implementations, the reconciliation report solicits information from a user regarding a transaction. For example, a reconciliation report may request that a user reconcile data associated with a transaction. After generating the reconciliation report, the process 500 returns.

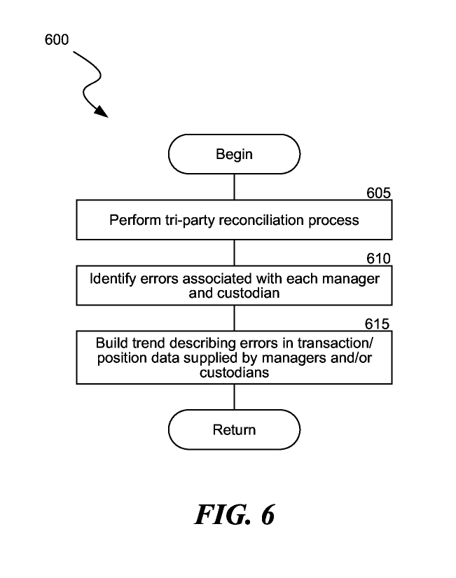

FIG. 6 is a flow diagram representing a process 600 performed by the tri-party reconciliation system 200 for identifying trends associated with errors in data supplied by various asset managers and custodians. The trends may help an entity identify problematic asset managers and custodians, such as those that are error-prone.

At a block 605, the tri-party reconciliation system 200 performs reconciliation with respect to at least one account held by an entity. For example, the tri-party reconciliation system may perform a reconciliation process like the process 300 described above with respect to FIG. 3. At a block 610, the tri-party reconciliation system identifies errors associated with at least one manager and/or custodian used by the entity. For example, the tri-party reconciliation system may sum all flags associated with manager transaction/position data, as identified in the process 300 described with respect to FIG. 3. At a block 615, the tri-party reconciliation system builds a trend that describes errors in transaction/position data supplied by managers and/or custodians. In some implementations, the trend identifies a quantity of errors in transaction/position data supplied by a manager or custodian over a period of time. In some implementations, the tri-party reconciliation system may also classify each error depending on the magnitude or severity of the error. Rather than a simple count of errors, the errors that are reported by the system may reflect a weighted sum of the errors that occurred. In this fashion, a manager having two significant errors may have a higher error score than a manager that made four minor rounding errors. In some implementations, the tri-party reconciliation system compares various managers and/or custodians used by the entity, making it easy for the entity to identify which managers and/or custodians are error-prone relative to others. The system may generate a trend report, including, for example, a table like Table 1 below, which identifies a quantity of errors associated with data supplied by various asset managers to an entity over a period of time.

TABLE 1
Errors by asset managers year-to-date.

| Asset | Asset | Asset | Asset |
|---|---|---|---|
| Manager 1 | Manager 2 | Manager 3 | Manager 4 |
| 15 | 20 | 4 | 67 |

In the example of Table 1, Asset Manager 4 has supplied data to the entity that includes more errors year-to-date than the other asset managers used by the entity. In some implementations, the tri-party reconciliation system identifies an error rate and/or other data. For example, an error rate may represent a rate of errors per 1000 transactions reported by a manager or custodian. Users of the system may use the trend data to compare the performance of asset managers, make decisions about when to audit and/or terminate a relationship with an asset manager, or otherwise ensure that asset managers are performing at a desired level of accuracy.

### CONCLUSION

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A method for reconciling financial data associated with an entity among three data sources, the method performed by a computing system having a processor and a memory, the method comprising:
identifying entity financial data associated with an entity and maintained by or on behalf of the entity;
receiving manager financial data associated with the entity from a manager of financial assets for the entity,
wherein the manager financial data is received on a periodic basis having a frequency of at least one time per business day;
receiving custodian financial data associated with the entity from a custodian of financial transactions for the entity,
wherein the custodian financial data is received on a periodic basis having a frequency of at least one time per business day;
comparing transactions described in entity financial data, manager financial data, and custodian financial data;
matching a transaction among the entity financial data, manager financial data, and custodian financial data;
identifying a property associated with the transaction that is common to the transaction among the entity financial data, manager financial data, and custodian financial data;
comparing a value of the property among the entity financial data, manager financial data, and custodian financial data;
identifying a difference in the value of the property among the entity financial data, manager financial data, and custodian financial data;
reconciling the value of the property,
wherein reconciling the value of the property includes selecting a reconciled value for the property based at least in part on the value of the property as specified by the entity financial data, the value of the property as specified by the manager financial data, and the value of the property as specified by the custodian financial data; and
storing the reconciled value of the property.

2. The method of claim 1, further comprising:
generating at least one of a manager reconciliation break and a custodian reconciliation break based at least in part on there being a difference between the reconciled value of the property and the value of the property as specified by the manager financial data and/or the value of the property as specified by the custodian financial data.

3. The method of claim 1, wherein selecting a reconciled value for the property includes selecting a value for the property that matches two of: the value of the property as specified by the entity financial data, the value of the property as specified by the manager financial data, and the value of the property as specified by the custodian financial data.

4. The method of claim 1, wherein storing the reconciled value of the property comprises replacing the value of the property as specified in the entity financial data with the reconciled value of the property.

5. The method of claim 1, further comprising generating a reconciliation report, wherein the reconciliation report identifies the matched transaction and the reconciled value of the property, the value of the property as specified by the entity financial data, the value of the property as specified by the manager financial data, and the value of the property as specified by the custodian financial data.

6. The method of claim 5, further comprising:
receiving a selection of one of the value of the property as specified by the entity financial data, the value of the property as specified by the manager financial data, and the value of the property as specified by the custodian financial data; and
replacing the reconciled value of the property with the value of the property associated with the selection.

7. The method of claim 1, further comprising:
generating a trend, wherein the trend specifies a quantity of errors associated with an asset manager and/or a custodian over time,
wherein an error is determined with respect to the asset manager based at least in part on there being a difference between the reconciled value of the property and the value of the property as specified by the manager financial data and an error is determined with respect to the custodian based at least in part on there being a difference between the reconciled value of the property and the value of the property as specified by the custodian financial data.

8. The method of claim 1, further comprising:
matching a position among the entity financial data, manager financial data, and custodian financial data;
identifying a position property associated with the position that is common to the transaction among the entity financial data, manager financial data, and custodian financial data;
comparing a position value of the property among the entity financial data, manager financial data, and custodian financial data;
identifying a difference in the value of the position property among the entity financial data, manager financial data, and custodian financial data;
reconciling the value of the position property,
wherein reconciling the value of the position property includes reconciled value for the position property based at least in part on selecting a the value of the position property as specified by the entity financial data, the value of the position property as specified by the manager financial data, and the value of the position property as specified by the custodian financial data; and
storing the reconciled value of the position property.

9. A method for reconciling financial data associated with an entity among three data sources, the method performed by a computing system having a processor and a memory, the method comprising:
identifying entity financial data associated with an entity and maintained by or on behalf of the entity;
receiving manager financial data associated with the entity from a manager of financial assets for the entity,
wherein the manager financial data is received after a financial market closes on a first day and prior to the financial market opening on a second day,
wherein the manager financial data is received on a periodic basis at a frequency of once per day;
receiving custodian financial data associated with the entity from a custodian of financial transactions for the entity,
wherein the custodian financial data is received after the financial market closes on the first day and prior to the financial market opening on the second day,
wherein the custodian financial data is received on a periodic basis at a frequency of once per day;
comparing transactions described in entity financial data, manager financial data, and custodian financial data;
matching a transaction among the entity financial data, manager financial data, and custodian financial data;
identifying that there is a difference in a value associated with the transaction among the entity financial data, manager financial data, and custodian financial data; and
reconciling the difference in the value, wherein reconciling the difference includes identifying a reconciled value.

10. The method of claim 9, further comprising:
generating at least one of a manager reconciliation break and a custodian reconciliation break, wherein the manager reconciliation break and the custodian reconciliation break are based at least in part on there being a difference between the reconciled value and the value associated with the transaction as specified by the manager financial data and the value associated with the transaction as specified by the custodian financial data.

11. The method of claim 9, wherein identifying a reconciled value includes selecting a value that is associated with the transaction in two of entity financial data, manager financial data, and custodian financial data.

12. The method of claim 9, wherein reconciling the difference in the value comprises replacing the value associated with the transaction as specified in the entity financial data with the reconciled value.

13. The method of claim 9, further comprising generating a reconciliation report, wherein the reconciliation report identifies at least one of the matched transaction and the reconciled value.

14. The method of claim 13, wherein the reconciliation report further identifies the value associated with the transaction as specified by the entity financial data, the value associated with the transaction as specified by the manager financial data, and the value associated with the transaction as specified by the custodian financial data, wherein the method further comprises:
receiving a selection of one of the value associated with the transaction as specified by the entity financial data, the value associated with the transaction as specified by the manager financial data, and the value associated with the transaction as specified by the custodian financial data; and
replacing the reconciled value with the value associated with the selection.

15. The method of claim 9, further comprising:
generating a trend, wherein the trend specifies a quantity of errors associated with an asset manager and/or a custodian over time,
wherein an error is determined with respect to the asset manager based at least in part on there being a difference between the reconciled value and the value associated with the transaction as specified by the manager financial data and an error is determined with respect to the custodian based at least in part on there being a difference between the reconciled value associated with the transaction and the value of the property as specified by the custodian financial data.

16. The method of claim 9, further comprising:
matching a position among the entity financial data, manager financial data, and custodian financial data;
identifying that there is a difference in a value associated with the position among the entity financial data, manager financial data, and custodian financial data; and
reconciling the difference in the value associated with the position, wherein reconciling the difference includes identifying a reconciled value.

17. A system for reconciling financial data associated with an entity among three data sources, the system comprising:
a memory storing computer-executable instructions of:
an aggregation module configured to aggregate entity financial data associated with an entity and maintained by or on behalf of the entity, manager financial data associated with the entity received from a manager of financial assets for the entity, and custodian financial data associated with the entity and received from a custodian of financial transactions for the entity,
wherein the manager financial data is received after a financial market closes on a first day and prior to the financial market opening on a following day,
wherein the manager financial data is received on a periodic basis at a frequency of once per day;
wherein the custodian financial data is received after the financial market closes on the first day and prior to the financial market opening on the second day,
wherein the custodian financial data is received on a periodic basis at a frequency of once per day; and
a reconciliation module configured to:
compare transactions described in entity financial data, manager financial data, and custodian financial data;
match a transaction among the entity financial data, manager financial data, and custodian financial data;
identify that there is a difference in a value associated with the transaction among the entity financial data, manager financial data, and custodian financial data; and
reconcile the difference in the value,
wherein reconciling the difference includes identifying a reconciled value; and
a processor for executing the computer-executable instructions stored in the memory.

18. The system of claim 17, further comprising:
a report generation module configured to generate at least one of a manager reconciliation break and a custodian reconciliation break, wherein the manager reconciliation break and the custodian reconciliation break are based at least in part on there being a difference between the reconciled value and the value associated with the transaction as specified by the manager financial data and the value associated with the transaction as specified by the custodian financial data.

19. The system of claim 17, further comprising a prediction module configured to predict a value for a predictable transaction based on entity financial data,
wherein the reconciliation module is further configured to:
compare the value for the predictable transaction based on entity financial data to a value for the predictable transaction as specified by the custodian financial data, and
store the value for the predictable transaction as specified by the custodian financial data if the value as specified by the custodian financial data differs from the value based on entity financial data.

20. The system of claim 17, wherein the reconciliation module is further configured to replace the value associated with the transaction as specified in the entity financial data with the reconciled value.

21. The system of claim 17, further comprising a report generation module configured to generate a reconciliation report, wherein the reconciliation report identifies at least one of the matched transaction and the reconciled value.

22. The system of claim 21, wherein the reconciliation report further identifies the value associated with the transaction as specified by the entity financial data, the value associated with the transaction as specified by the manager financial data, and the value associated with the transaction as specified by the custodian financial data,
wherein the system further comprises a user interface module configured to receive a selection from a user of one of the value associated with the transaction as specified by the entity financial data, the value associated with the transaction as specified by the manager financial data, and the value associated with the transaction as specified by the custodian financial data,
wherein the reconciliation module is further configured to flag the selection from the user.
